(19) United States
(12) Patent Application Publication
(10) Pub. No.: US 2008/0231040 A1
(43) Pub. Date: Sep. 25, 2008

(54) SECURITY DOCUMENT WITH FADE-WAY PORTION

(76) Inventors: Gene F. GAFFNEY, Wantagh, NY (US); William R. O'Brien, North Massapequa, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/050,576

(22) Filed: Mar. 18, 2008

Related U.S. Application Data
(60) Provisional application No. 60/895,585, filed on Mar. 19, 2007.

(51) Int. Cl. B42D 15/00

(52) U.S. Cl. 283/93

(57) ABSTRACT

The present invention is directed to a method and system for printing documents with a security image. The security image is formed of dots of a particular size and arranged in a pattern. The size and pattern are selected such that when the printed document is copied on a standard printer the security image is faded or invisible and therefore the resulting copy is clearly not an original document.

### RELATED APPLICATIONS

This application claims priority to U.S. Provisional Application Ser. No. 60/895,585 filed on Mar. 23, 2007 and incorporated herein by reference.

The subject matter of this application is also related to application Ser. No. 12/019,304 filed Jan. 24, 2008 and also incorporated herein by reference.

### BACKGROUND OF THE INVENTION

A. Field of Invention

This invention pertains to a system and method for printing an image on a sheet of paper. When the paper is photocopied the image on the copy looks faded or disappears thereby providing an indication that it is a copy.

B. Description of the Prior Art

In general, laser printers are prevalent in offices, homes and other locations. These printers print by means of placing dots on a page. Dots are generally places adjoining other dots to form characters or images on the page. Laser printers have evolved to the point of having the ability to place dots of such small diameter that the printer can generate characters of 1800 dots per inch (dpi) or more.

Office copiers are also prevalent. These copiers include photocopiers, which operate by capturing a digital photograph of or by scanning an “original” document. Often, especially after a copier has been in use for a while, artifacts and other marks appear on copies that mar their appearance and, if there are too many of them, the copies are no longer useable. If these imperfections are due to specks of dust and dirt on the glass supporting the original or other intermediate surfaces, then cleaning may eliminate them. However, sometimes the imperfections are due to permanent defects on some copier elements that cannot be removed unless the whole element is removed. Copiers presently have the ability to eliminate undesired markings through sophisticated filtering techniques that identify these imperfections as “noise” and to eliminate them when making a copy. One commonly used technique makes use of an algorithm which first determines the size of each distinct mark on an image of an original and then, if this size falls below a threshold value, assumes that the mark is an undesirable imperfection and eliminates it in copying.

Because of the above-described feature, as well as several other features and processes not discussed in detail here, modern copiers perform so well that it is sometimes very difficult to determine whether a particular document is an original or a copy. In most instances, this is in fact the goal of the copier manufacturers and the requirement of the copier users. However, in some instances, this also creates a problem because the copiers may compromise the security of certain documents such as official documents, commercial instruments, and the like.

Document security has been a long time concern, particularly for governmental agencies and financial institutions. In order to provide assurance that a document is genuine, documents have been printed on paper having special characteristics. For example, it is very common to provide official documents, including bank notes and financial instruments, on paper that is embossed and/or imprinted with a fine design that is difficult to reproduce or copy. Moreover, some of the patterns imprinted on the paper are constructed and arranged to be almost invisible to the naked eye on an original document but produce a very clear mark when reproduced on a copier, thereby indicating that a corresponding document is not genuine but has been copied. Various techniques for generating these types of documents have been developed, for example, by Document Security Systems, Inc. of Rochester, N.Y.

### SUMMARY OF THE INVENTION

This invention pertains to a system and method for printing documents with a security image, thus providing a certification that the document is genuine or original, and not a copy. A printer in communication with a computer performs the printing function.

A method and system is provided wherein a string of alphanumeric characters or images is converted into a security image. The security image may be defined by a customer and may be different for each document or it may be a standard string, graphic element(s), or some combination that is used for a number of documents.

As discussed above, present office copiers use sophisticated algorithms employing techniques for eliminating undesirable artifacts. In order to leverage these automatically employed algorithms, in the present invention a pattern of dots is used, the pattern being selected so that the dots are misinterpreted by the algorithm as unwanted artifacts. As a result, when an original document with this pattern of dots is copied, the dot pattern is either not reproduced at all, or reproduced faintly or incompletely. Thus the pattern of dots can be used as a security feature that automatically provides an indication of whether a document is an original or has been photocopied.

In one embodiment, the technique of the present invention is used to generate a security image on a document that is separate from any other content thereon. In another embodiment, this technique introduces a pattern of dots as a background security image, with each dot smaller than the noise threshold of copiers. The technique requires a spacing between dots such that the pattern of dots forms a visible image on a laser-printed original, but becomes faded or non-existent when the original is photocopied. The result is that one may readily distinguish originals from photo copies. In another embodiment, information in certain fields of a document is displaced with a security image formed of the described dot patterns.

In effect, these dot images result in a security image embedded into an original document. This system and method allows for establishing these security fonts that fade away with copying. More particularly, a font image is created with the correct spacing of dots such that the dots would not be copied or scanned but could be printed or viewed on a screen.

The invention accordingly comprises the several steps and the relation of one or more such steps with respect to each of the others, combination of elements which are adapted to affect such steps, properties and relation of elements, all as exemplified in the detailed disclosure hereinafter set forth, and the scope of the invention will be indicated in the claims.

### BRIEF DESCRIPTION OF THE DRAWINGS

FIG. 1 depicts a blank page prior to security font image printing;

FIG. 2 depicts a page with a security font image printed on the page;

FIG. 3 depicts a page with a security font image printed on the page together with additional non-security font text and graphics;

FIG. 4 depicts a photocopied version of the page of FIG. 3;

FIG. 5 depicts a flow chart of the creation of a document which includes a security image;

FIG. 6 depicts a grid of four dots used for generating the dot pattern for a security image in accordance with this invention; and

FIG. 7 shows a table listing various of standard printers and the corresponding nominal dot sizes.

### DETAILED DESCRIPTION OF THE INVENTION

In the present invention, a security image is described that consists of a pattern of dots. In the pattern the dots are arranged so that they do not touch one another. Moreover, the pattern is such that a user may recognize the pattern as a visual image. For example, the image may include a combination of alphanumeric characters, representations, pictures, caricature of a certain object or person, and so on.

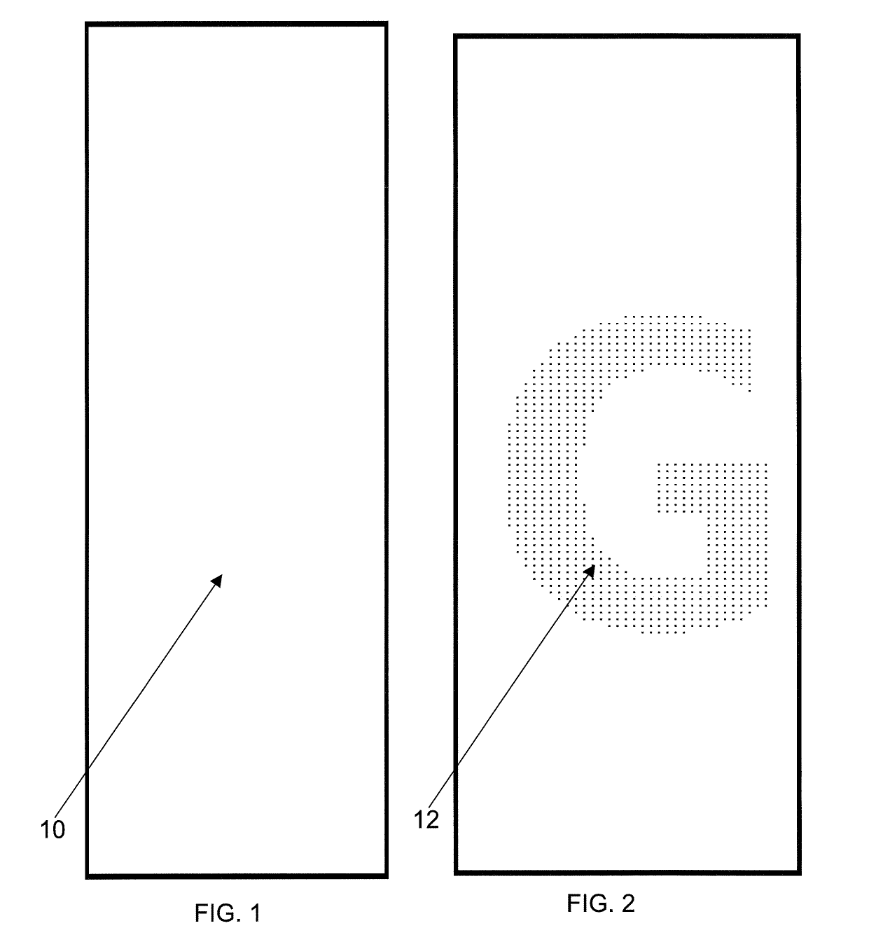

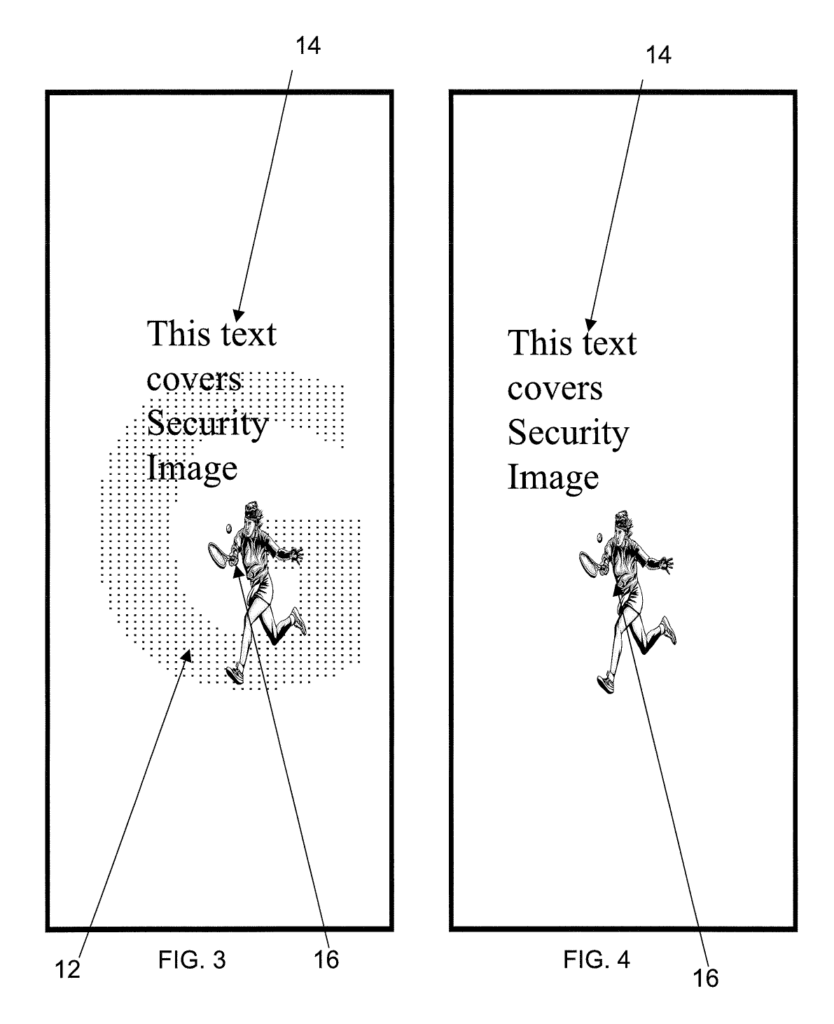

Starting with FIG. 1, a document is formed as follows. Initially a blank page 10 is provided with no visible markings. Then a security image is selected for the document. FIG. 2 shows such a security image, in the form of a letter “G” 12. The security image 12 can be used as an independent document element, or as shown in FIG. 3, it may be provided as background and the content or other document elements such as text 14 and/or a picture 16 are superimposed over the security image 12. It should be understood that the documents shown in FIGS. 1-4.

In accordance with the present invention, the security image is formed as as a pattern of dots having a predetermined separation. The spacing between the dots and the size of the dots is selected so that the dots in the pattern are misinterpreted by the filtering algorithm of a copier to be artifacts or noise. Of course, the dot pattern must also match the capabilities of a standard laser printer. For example, for a laser printer operating at 1200 dpi, a dot typically has a diameter of about 0.000833 inches.

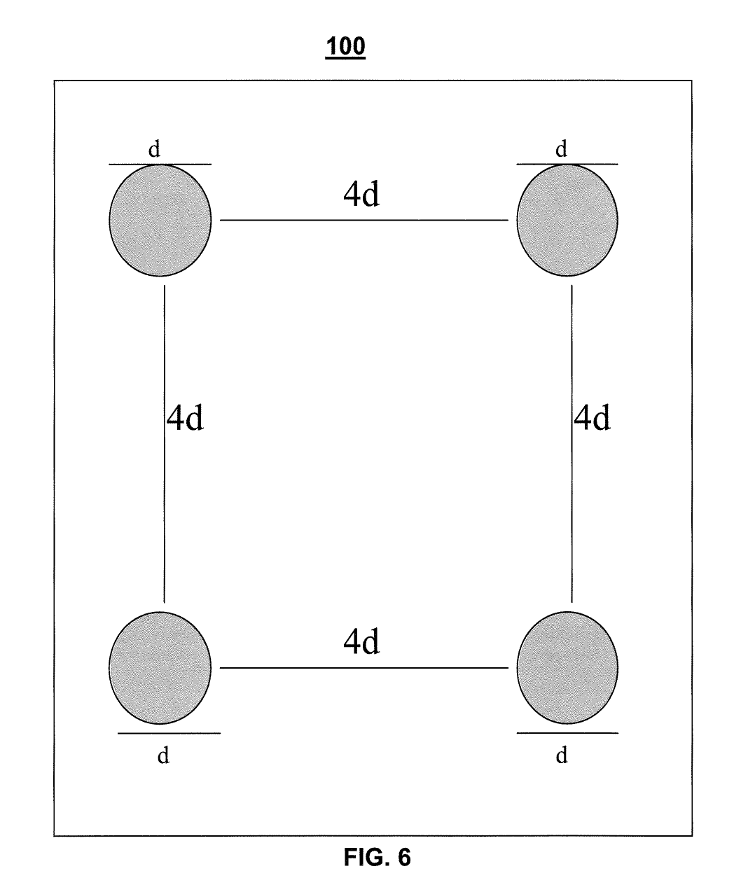

The dots are printed in a grid pattern having the same spacing in the vertical and horizontal direction. For example, as shown in FIG. 6, the dot pattern may be laid out along a grid of dots 100, each dot having a diameter d and a spacing s in the range of 4-16 d. In the preferred embodiment, s=4 d. In FIG. 6 the dots 100 are shown as having a circular shape, however it should be understood that these dots may have other shapes as well, depending on the characteristics of the respective printer, the ink used, the paper on which the document is printed, and so on.

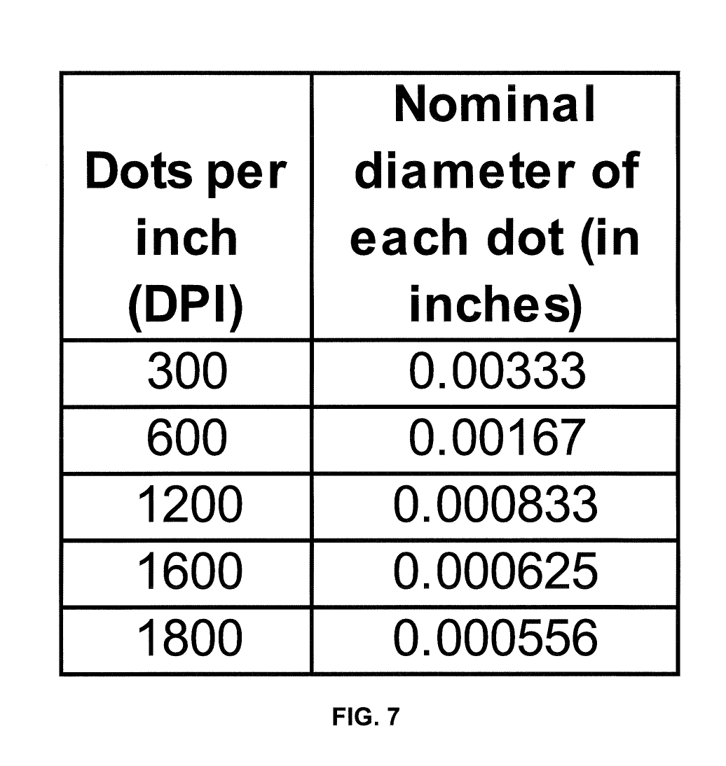

FIG. 7 shows preferred the nominal sizes of the dots formed by printers having a nominal output of 300, 600, 1200, 1600 and 1800 dpi.

Each of the security images may be generated using appropriate graphic software. Alternatively, a library may be generated with a plurality of security elements, each element corresponding to an alphanumeric character. A security image is then generated by combining several characters. For example, the security image “ORIGINAL” is generated according to this embodiment by combining the security elements corresponding to the characters I, R, I, G, I, N, A, and L.

FIG. 3 shows a final document 14 having the security image 12 as a background and superimposed text 14 or image 16. When the document of FIG. 3 is fed to a photo copier, in the resulting copy, the dots making up the letter G either disappear completely, come out faint, or some of the dots fade out completely. FIG. 4 for example depicts a simulated photocopy in which the dot pattern forming the security image 12 disappears completely.

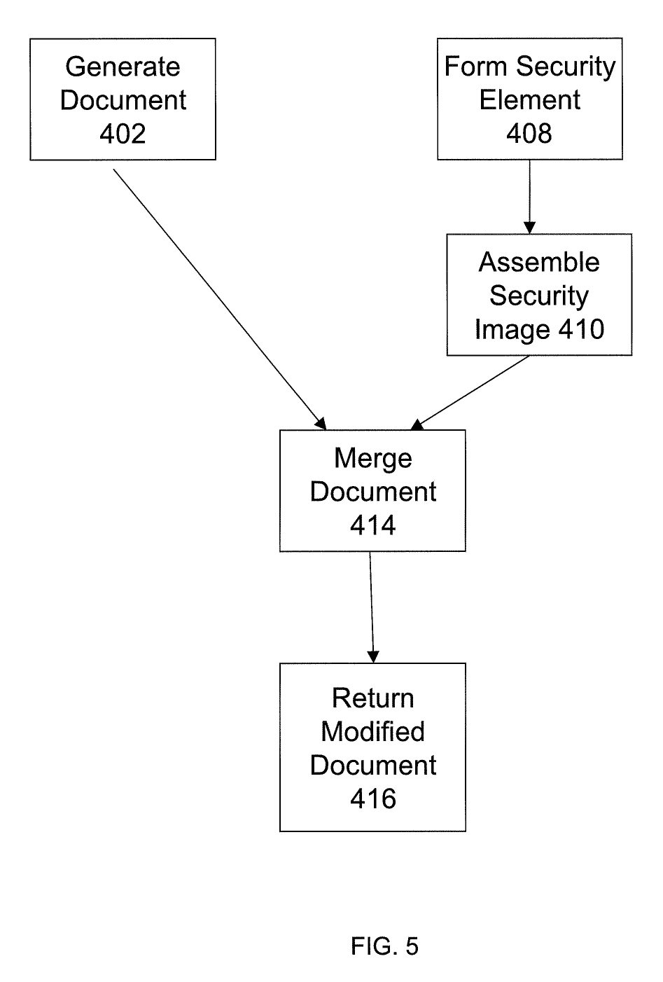

Documents with a security element can be generated using several different processes. FIG. 5 depicts a flow chart of one such process. In general, a document is prepared using computer-based software, such as Microsoft Word (step 402). In step 408, a security element is formed, which may be formed of several characters in requested positions on a page. The security image is assembled (step 410) and merged with the generated document (step 414). The result is a modified document (step 416) that may look like the one on FIG. 3.

In another embodiment of the present invention composition software is used for creating the security image 12 on a computer monitor with a keyboard (not shown). In this embodiment, a user can build a security image for later use. A user may select a series of alphanumeric characters, a picture, an image, or some combination, as well as their size and placement on a page. For example, a user may select the document title or the word “ORIGINAL.” As the user creates the security image, it is rendered on the monitor as ordinary text using the display resolution of the monitor. The selected image is then converted into a security image using dots having a predetermined spacing as described above. The user may save the security image locally or at a remote location.

Once created, security images may be stored in a library and accessed by a user as necessary. For example, software may be installed on a user's computer such that every time certain file types are prepared, such as Microsoft Word files, the user is given the option of selecting a security image from a library. Alternatively, the user may be given the option of creating unique security image as discussed.

These security images may be stored locally on the user's computer or remotely in a database on a server. When the security images are stored remotely, they may be used in several different ways. In one embodiment, a user generates a document with text and/or images and sends the document to a remote server. The remote server then applies a security image to the document and the composite document is then returned to the user or, optionally, sent to another party. Alternatively, a user requests a security image from the server. The server returns the security image, and the user then incorporates the security image into his document. In either case, the resulting document includes the selected security image and if a copy is made of the document on a standard copier, the security image will be either be missing or it will be faded.

The technique presented herein can be used in many different ways. In the examples provided above, a security image is added as a separate document element or as a background to a document. Alternatively, the security image can be incorporated into specific fields of a document. The fields may include some specific information such as a number, a name or any other highly sensitive information. For example, the document with the fields having sensitive information in plain text is passed to a security program, which then replaces the sensitive information with a corresponding security image, for example, by using a library of security elements and replacing each alphanumeric character in plain text within the sensitive fields with corresponding security images. When the resulting document is copied, the text in the sensitive fields either disappears or looks faded.

In another embodiment, the invention is used to generate a security image. The image can be placed on any application that can handle graphical images. However, the image must have the characteristics discussed above.

It is also to be understood that the following claims are intended to cover all of the generic and specific features of the invention herein described, and all statements of the scope of the invention which, as a matter of language, might be said to fall therebetween.

We claim:

1. A system for generating original documents comprising:
a document receiver receiving a document with plain content;
a modified document generator generating a modified document by merging a security image with said plain document wherein, said security image includes a plurality of dots arranged in a dot pattern;
wherein said dot pattern has characteristics selected to result in a security image when said modified document is printed as an original document; and
wherein said dot pattern has characteristics selected to result in a modified security image on a copy generated when said original document is reproduced on a copier, the copier operating using an artifact elimination process that eliminates undesired artifacts.

2. The system of claim 1 wherein said characteristics are dependent on said artifact elimination process.

3. The system of claim 1 further comprising a library of security images, said security image being selected from said library.

4. The system of claim 1 further comprising a security image generator selectively generating said security image.

5. The system of claim 1 further comprising a server remotely located from said document generator, said security image generator being incorporated in said server.

6. The system of claim 1 wherein said security image includes security elements corresponding to a predetermined string of alphanumeric characters.

7. The system of claim 1 wherein said security image includes security elements corresponding to a picture or icon.

8. The system of claim 1 wherein said dot pattern includes a dot pattern arranged in a two dimensional grid.

9. The system of claim 8 wherein the dots of the pattern are arranged at a constant horizontal and vertical distance from each other.

10. The system of claim 9 wherein said dots have a nominal dot diameter and said distance is an integer of said nominal dot diameter.

11. The system of claim 10 wherein said distance is in the range of 4-16 times said dot diameter.

12. The system of claim 1 wherein said plain text document includes a field with sensitive information and wherein said modified document generator replaces the sensitive information with said security image.

13. The system of claim 1 wherein said document generator is a laserjet printer.

14. A method of printing a secure document comprising:
receiving a plain document;
merging said plain document and a security image to form a secure document; and
printing said secure document to form an original document, wherein said original document includes a visible version of said security image having characteristics that identify said original document as genuine;
wherein copying said original documents on a copier operating with an artifact elimination process that eliminates undesirable artifacts when making copies results in a copied document that includes a modified version of the security image, the dot pattern being selected to insure that the modified version does not identify the copied document as an original document.

15. The method of claim 14 wherein the secure elements of said secure image define a predetermined string of alphanumeric characters.

16. The method of claim 14 further generating a library of said security images.

17. The method of claim 14 wherein the security image includes a plurality of dots arranged in a grid, the dots on the grids being separated by a distance equal to an integer multiple of the nominal dot size.

18. An apparatus for generating a document with a security element comprising:
a processor receiving said security image; and
a database storing a library of security images, each security element being formed of a collection of untouching dots;
wherein said processor selects a plurality of security elements from said library corresponding said string of characters and joins them seamlessly to form said security image.

19. The apparatus of claim 18 wherein said processor further sizes the security image to render it more visible on a monitor.

20. The apparatus of claim 19 wherein said processor sizes the security image based at least on one of a monitor and a printer resolution.
